(19) United States
(12) Patent Application Publication
(10) Pub. No.: US 2017/0246902 A1
(43) Pub. Date: Aug. 31, 2017

(54) Spiral Notebook Pen Holder

(71) Applicant: Micah Thurlow, Bedford, TX (US)

(72) Inventor: Micah Thurlow, Bedford, TX (US)

(21) Appl. No.: 15/054,126

(22) Filed: Feb. 25, 2016

(51) Int. Cl. B43K 23/00

(52) U.S. Cl. CPC B43K 23/001

(57) ABSTRACT

A pen holder for engaging a spiral coil of a notebook includes a planar body sized to be inserted into the spiral coil of the notebook having first and second straight edges, a series of slotted perforations defined along the first straight edge and configured to mesh with the spiral coil of the notebook, and a plurality of horizontal slots arranged in a column parallel with the series of slotted perforations and configured to engage a clip of a writing instrument.

### FIELD

The present disclosure relates to the field of stationary and accessories, and in particular to a pen holder for a spiral-bound notebook.

### BACKGROUND

The spiral-bound notebook is ubiquitous in many settings, including schools, offices, and home. The spiral-bound notebook typically includes a stack of sheets of paper that have a series of perforations placed along one edge of the papers. A spirally-wound coil is wound through these perforations to neatly bind the notepapers together.

### BRIEF DESCRIPTION OF THE DRAWINGS

FIG. 1 is a front elevational view showing a spiral notebook equipped with an exemplary embodiment of a pen holder according to the present disclosure;

FIG. 2 is a front perspective view showing a spiral notebook equipped with an exemplary embodiment of a pen holder according to the present disclosure;

FIG. 3 is a front view showing a first exemplary embodiment of a pen holder according to the present disclosure;

FIG. 4 is a front perspective view showing a second exemplary embodiment of a pen holder according to the present disclosure;

FIG. 5 is a front view showing the first exemplary embodiment of a pen holder holding a pen according to the present disclosure;

FIG. 6 is a back perspective view showing the second exemplary embodiment of a pen holder holding a pen according to the present disclosure;

FIG. 7 is a front perspective view showing the first exemplary embodiment of a pen holder engaging a spiral coil according to the present disclosure;

FIG. 8 is a front view showing a secondary exemplary embodiment of a pen holder according to the present disclosure;

FIG. 9 is a front perspective view showing the second exemplary embodiment of a pen holder according to the present disclosure;

FIG. 10 is a front perspective view showing a third exemplary embodiment of a pen holder in its flat configuration according to the present disclosure;

FIG. 11 is a back perspective view showing the third exemplary embodiment of a pen holder in its folded configuration according to the present disclosure;

FIG. 12 is a front perspective view showing the third exemplary embodiment of a pen holder holding a pen according to the present disclosure;

FIG. 13 is a back perspective view showing a third exemplary embodiment of a pen holder holding a pen according to the present disclosure;

FIG. 14 is a front perspective view showing a fourth exemplary embodiment of a pen holder according to the present disclosure;

FIG. 15 is a back perspective view showing the fourth exemplary embodiment of a pen holder holding a pen according to the present disclosure; and

FIG. 16 is a front perspective view showing the fourth exemplary embodiment of a pen holder holding a pen according to the present disclosure.

### DETAILED DESCRIPTION

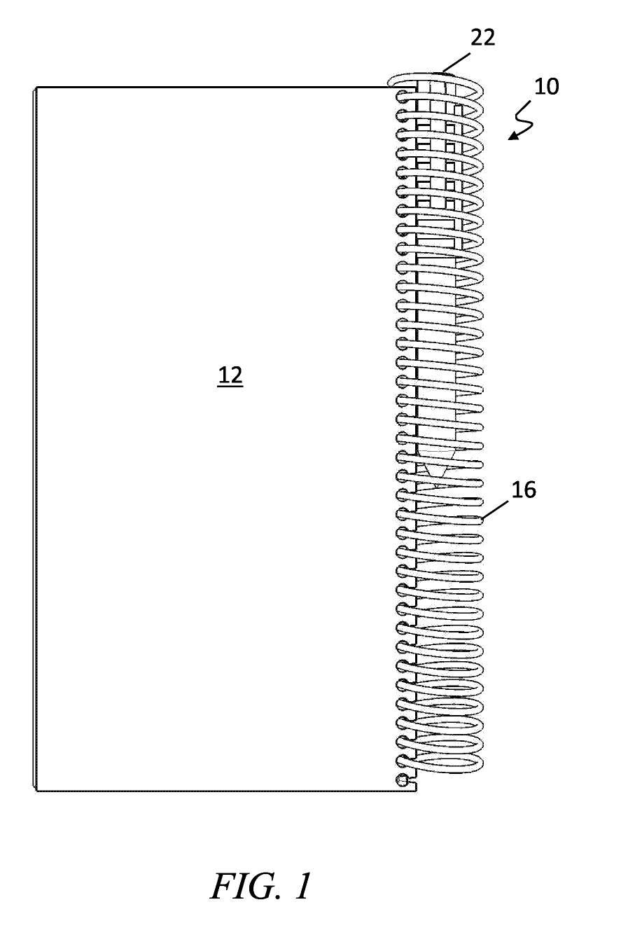

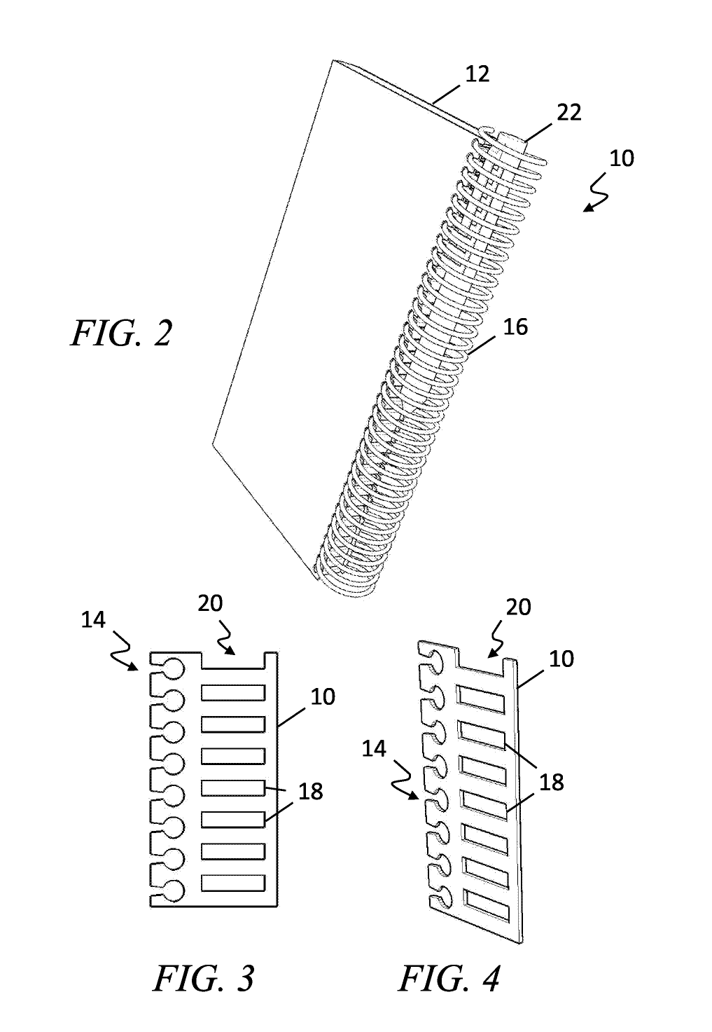

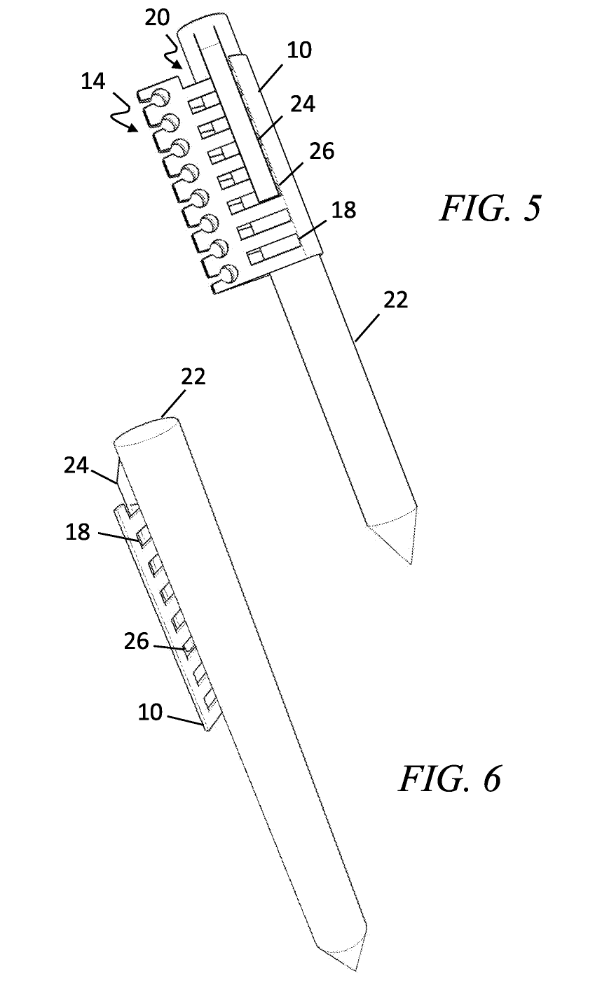

FIG. 1 is a front elevational view showing a first exemplary embodiment of a pen holder 10 installed in a spiral notebook 12 to hold a pen 22 according to the present disclosure. Referring also to FIGS. 2-6, the first exemplary embodiment of the pen holder 10 is a flat piece of somewhat rigid but flexible material, such as plastic, stiffened fabric, metal, cardboard, etc., that has a column of slotted perforations 14 defined along one elongated edge configured to mesh or engage with the spiral coil 16 of the notebook. The body of the pen holder 10 further includes at least one rectangular horizontal slot 18. The pen holder 10 preferably includes a plurality of horizontal slots 18 arranged in a column parallel with the slotted perforations 14 at the elongated edge of the pen holder 10. Each slotted perforation 14 have a narrowed opening similar to a keyhole silhouette. The pen holder 10 preferably further includes a rectangular indentation 20 near a top (and/or bottom) edge of the pen holder 10. The pen holder 10 is preferably rectangular in shape like the horizontal slots, but may take on other shapes.

Referring to FIGS. 1, 2, 5, and 6, it may be seen that the pen holder 10 can “hold” a writing instrument 22 by allowing the clip 24 of the pen 22 to slide over the pen holder 10 so that the thicker tip 26 of the clip 24 can come into contact with the body of the pen through one of the slots 18. Any writing instrument 22, including a ball-point pen, roller-ball pen, mechanical pencil, etc. that incorporates a similar clip can be securely held by the pen holder this way.

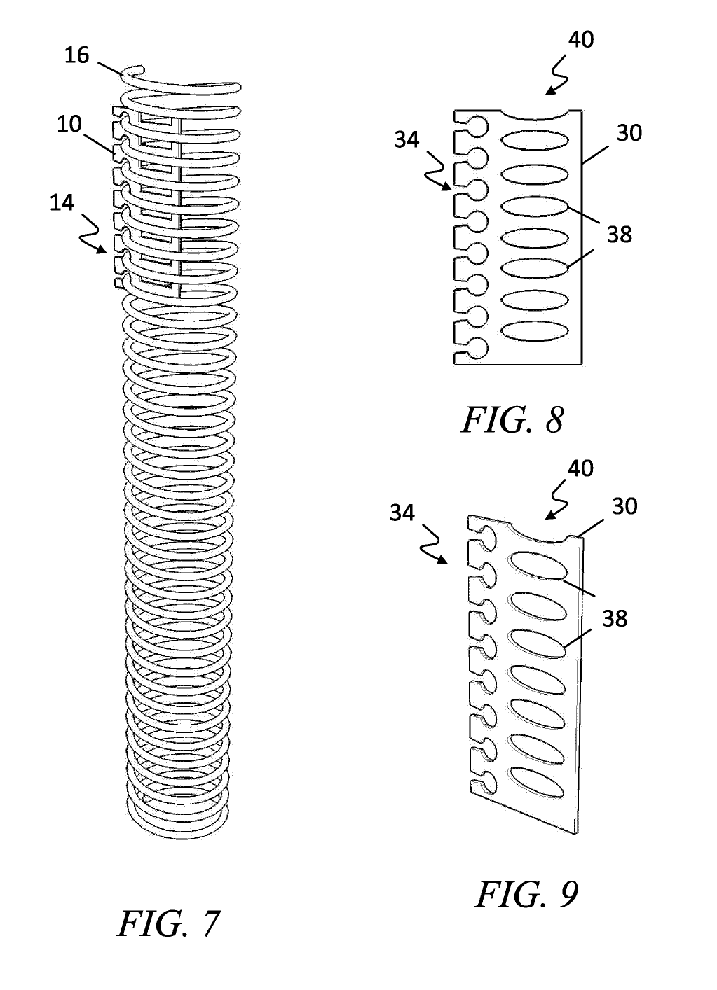

FIG. 7 further shows the detail of the slotted perforations 16 disposed along the edge of the pen holder 10 meshed with the helical spiral coil 16 of the notebook, where the notebook itself is not shown for the sake of clarity. The width of the pen holder 10 is selected to be compatible with the radius of the spiral coil so that it can be easily inserted into its center. The spacing of the slotted perforations 14 are chosen such that they are compatible with the pitch of the helical coil so that the pen holder can easily slide into and engage the helical coil. The narrowed opening of the keyhole-shaped slotted perforations 14 help the pen holder 10 to stay securely engaged with the spiral coil 16.

FIGS. 8 and 9 are front and front perspective views showing a second exemplary embodiment of a pen holder 30 according to the present disclosure. The second exemplary embodiment of the pen holder 30 is similar to the first embodiment also comprising a flat rectangular piece of somewhat rigid but flexible material, such as plastic, stiffened fabric, metal, cardboard, etc., that has a column of slotted perforations 34 defined along one elongated edge configured to mesh or engage with the spiral coil 16 of the notebook. The body of the pen holder 30 further includes a plurality of oval or elliptical horizontal slots 38 that is oriented perpendicularly to the elongated edge. The pen holder 30 preferably further includes an oval indentation 40 near a top edge of the pen holder 30. The pen holder 30 is preferably rectangular in shape, but may take on other shapes.

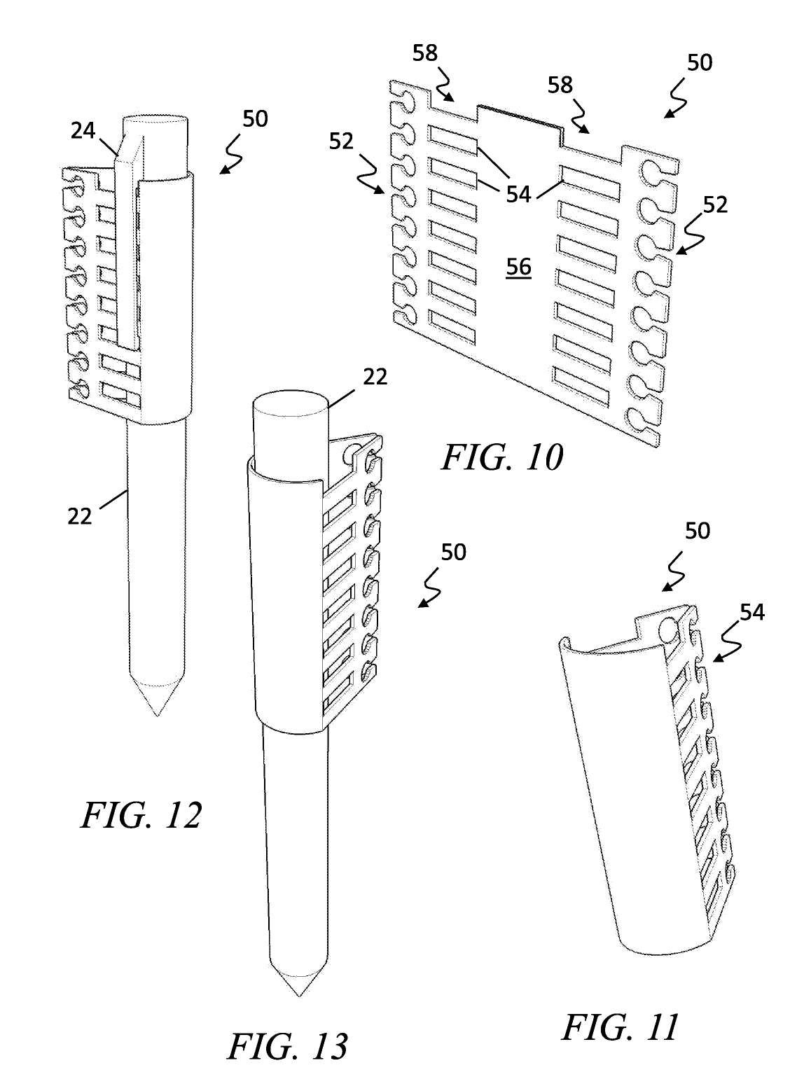

FIG. 10 is a front perspective view showing a third exemplary embodiment of a pen holder 50 in its flat configuration according to the present disclosure. The third exemplary embodiment of the pen holder 50 also comprises a flat rectangular piece of somewhat rigid but flexible material, such as plastic, stiffened fabric, metal, cardboard, etc., that has two parallel columns of slotted perforations 52 defined along two parallel elongated edges configured to mesh or engage with the spiral coil 16 of the notebook. The body of the pen holder 50 further includes a plurality of rectangular horizontal slots 54 arranged in two spaced-apart columns that define a vertical spine 56 between them that is oriented parallel with the elongated edges. The pen holder 50 preferably further includes rectangular indentations 58 near a top edge of the pen holder 50. The pen holder 50 is preferably rectangular in shape, but may take on other shapes.

FIG. 11 is a back perspective view showing the third exemplary embodiment of the pen holder 50 in its folded configuration according to the present disclosure. It may be seen that the material is folded so that the slotted perforations 52 along the vertical edges are overlapping. The folded pen holder 50 defines an elongated space with a three-sided cross-section for accommodating a writing instrument 22. This pen holder 50 can also be easily installed into the spiral coil of a notebook.

FIGS. 12 and 13 show the third exemplary embodiment of the pen holder 50 holding a writing instrument 22 according to the present disclosure. The writing instrument 22 can be easily inserted into the space formed in the pen holder 50 and its clip 24 can be easily used to secure the pen 22 onto the pen holder 50. Any writing instrument 22, including a ball-point pen, roller-ball pen, mechanical pencil, etc. that has a similar clip can be securely held by the pen holder 50 this way.

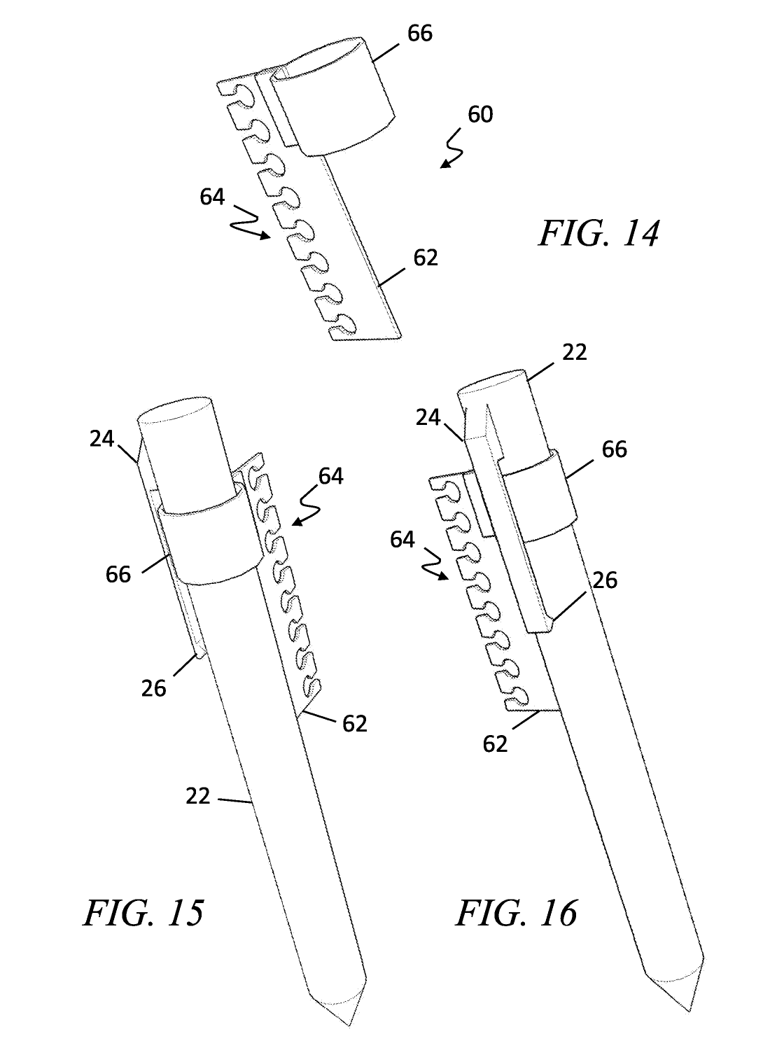

FIG. 14 is a front perspective view showing a fourth exemplary embodiment of a pen holder 60 according to the present disclosure. The pen holder 60 includes a generally rectangular strip 62 of somewhat rigid but flexible material, such as plastic, stiffened fabric, metal, cardboard, etc. that includes a series of slotted perforations 64 along one edge. Further, the pen holder 60 includes a generally circular loop 66 that is securely attached to the rectangular strip 62. The loop 66 may be formed of the same or different material as the rectangular strip 62. As shown in FIGS. 15 and 16, the loop 66 of the pen holder 60 is configured to receive the pen 22 and securely hold it. The radius of the loop 66 is selected so that it would accommodate most writing instruments 22. The length of the clip 24 allows the thick tip 26 of the clip 24 to slip over the loop 66 and engage the body of the pen and thus securing the pen 22 to the pen holder 66. It should be noted that a loop with another cross-sectional shape, such as circular, square, triangular, hexagonal, and rectangular, can also be used.

FIGS. 15 and 16 show the back and front perspective views of the fourth exemplary embodiment of the pen holder 66 according to the present disclosure. Any writing instrument 22, including a ball-point pen, roller-ball pen, mechanical pencil, etc. that incorporates a similar clip can be securely held by the pen holder 60 this way.

Because the spiral coil of notebooks may have different dimensions (i.e., radius and pitch), It should be noted that the overall dimensions of the pen holder and spacing and size of the slotted perforations of the pen holder may be chosen so that the pen holder may easily slip into the center of the spiral coil and that the slotted perforations may easily mesh with the spiral coil. It should be noted that the perforated slots and the horizontal slots can take on shapes other than what is explicitly described and shown herein. For example, the horizontal slots may be circular, square, or triangular openings. Further, the pen holder size, dimensions, and features can also be adapted to work with split-ring binding systems. For example, the pen holder may be much longer and only have two perforated slots (or just openings not connected to the edge) to engage at least two split rings of the binder.

The features of the present invention which are believed to be novel are set forth below with particularity in the appended claims. However, modifications, variations, and changes to the exemplary embodiments described above will be apparent to those skilled in the art, and the spiral notebook pen holder described herein thus encompasses such modifications, variations, and changes and are not limited to the specific embodiments described herein.

What is claimed is:

1. A pen holder for engaging a spiral coil of a notebook, comprising:
a planar body sized to be inserted into the spiral coil of the notebook having first and second straight edges;
a series of slotted perforations defined along the first straight edge and configured to mesh with the spiral coil of the notebook; and
a plurality of horizontal slots arranged in a column parallel with the series of slotted perforations and configured to engage a clip of a writing instrument.

2. The pen holder of claim 1, wherein each of the plurality of horizontal slots are rectangular in shape.

3. The pen holder of claim 1, wherein each of the plurality of horizontal slots are oval in shape.

4. The pen holder of claim 1, wherein each of the slotted perforations has a keyhole shape.

5. The pen holder of claim 1, wherein each of the slotted perforations has a narrower opening.

6. The pen holder of claim 1, further comprising:
a second series of slotted perforations defined along the second straight edge parallel with the first series of slotted perforations; and
a second plurality of horizontal slots arranged in a second column parallel with and spaced apart from the first column of horizontal slots.

7. The pen holder of claim 1, wherein the planar body is constructed of a material selected from the group consisting of plastic, stiffened fabric, metal, and cardboard.

8. The pen holder of claim 1, wherein the planar body further defines a horizontal rectangular indentation along a top edge thereof.

9. A pen holder for engaging a binding of a notebook, comprising:
a planar body sized to be inserted into a cylindrical space defined by the binding of the notebook having first and second straight edges;
at least two slotted perforations defined along the first straight edge and configured to mesh with the binding of the notebook; and
at least one opening defined in the planar body and configured to engage a clip of a writing instrument.

10. The pen holder of claim 9, wherein the at least two slotted perforations are configured to mesh with a split-ring binding of a binder.

11. The pen holder of claim 9, further comprising a series of slotted perforations defined along the first straight edge and configured to mesh with a spiral coil of the notebook.

12. The pen holder of claim 10, further comprising a plurality of horizontal slots arranged in a column parallel with the series of slotted perforations and configured to engage a clip of a writing instrument.

13. The pen holder of claim 12, further comprising:
a second series of slotted perforations defined along the second straight edge parallel with the first series of slotted perforations; and
a second plurality of horizontal slots arranged in a second column parallel with and spaced apart from the first column of horizontal slots.

14. The pen holder of claim 9, wherein each of the at least two slotted perforations has a keyhole shape.

15. The pen holder of claim 9, wherein each of the at least two slotted perforations has a narrower opening.

16. The pen holder of claim 9, wherein each of the at least two slotted perforations are slotted openings defined along the edge of the planar body without opening to the edge thereof.

17. A pen holder for engaging a spiral coil of a notebook, comprising:
a generally rectangular planar strip sized to be inserted into the spiral coil of the notebook having first and second straight edges;
a series of slotted perforations defined along the first straight edge and configured to mesh with the spiral coil of the notebook; and
a loop attached to the planar strip and configured to encircle a writing instrument and engage a clip of the writing instrument.

18. The pen holder of claim 17, wherein the loop has a cross-sectional shape selected from the group consisting of circular, square, triangular, hexagonal, and rectangular.

19. The pen holder of claim 17, wherein the planar strip and loop are constructed of a material selected from the group consisting of plastic, stiffened fabric, metal, and cardboard.

20. A pen holder for engaging a binding of a notebook, comprising:
a planar body sized to be inserted into a cylindrical space defined by the binding of the notebook having first and second straight edges;
at least two slotted perforations defined along the first straight edge and configured to mesh with a split-ring binding of a binder; and
at least one opening defined in the planar body and configured to engage a clip of a writing instrument.
